(19) United States
(12) Patent Application Publication
(10) Pub. No.: US 2007/0264384 A1
(43) Pub. Date: Nov. 15, 2007

(54) Molded article holder

(75) Inventors: Derek Robertson McCready, Mississauga (CA); William James Andrew Jacovich, Newmarket (CA); Harold Arthur DeVisser, Caledon East (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/432,881

(22) Filed: May 12, 2006

(51) Int. Cl. B29C 49/00

(52) U.S. Cl. 425/533

(57) ABSTRACT

Disclosed, amongst other things, is: (i) molded article holder (450) having a retainer (480) that is snap-engagable with an insert (470); (ii) a retainer (480), for a molded article holder (50), that is snap-engagable with an insert (470); and (iii) an insert (470), for a molded article holder (450), that is snap-engagable with a retainer (480).

### TECHNICAL FIELD

The present invention generally relates to, but is not limited to, molding systems, and more specifically the present invention relates to, but is not limited to, (i) a molded article holder; (ii) a retainer for a molded article holder; and (iii) an insert for a molded article holder, amongst other things.

### BACKGROUND

Some injection molded parts, for example plastic preforms of the variety that are for blow molding into beverage bottles, require extended cooling periods to solidify into substantially defect-free molded parts. To the extent that the cooling of the molded part can be effected outside of the injection mold by one or more post-mold holding devices then the productivity of the injection mold may be increased (i.e. lower cycle time). A variety of such post-mold holding devices, and related methods, are known and have proven effective at the optimization of the injection molding machine cycle time.

In a typical injection molding system, such as the system 10 depicted with reference to FIG. 1A, and as generally described in commonly assigned U.S. Pat. No. 6,171,541 (Inventor: NETER, Witold, et al.; Published: 9 Jan. 2001), just-molded, and hence partially cooled, molded articles 2 are ejected from the mold half 8, when the mold halves 8, 9 are spaced apart, and into molded article holders 50 (i.e. commonly known as a cooling tube, a take-off tube, or a cooling pipe, amongst others). The holders 50 are arranged on a molded article holding device 15 (i.e. commonly known as an end-of-arm-tool, carrier plate assembly, removal device, post-cooling apparatus, amongst others), the holding device 15 arranged to be cyclically positioned between an in-mold position, between the mold halves 8, 9, to receive the molded articles 2, and an out-board position, as depicted, to allow the mold halves 8, 9 to close and begin another molding cycle. Preferably, the molded articles 2 are held in the holders 50 until the molded articles 2 have cooled sufficiently that they may be ejected without risk of further deformation. While held in the holders 50, the cooling of the molded articles 2 may be assisted by the use of cooling/extraction pins 14 expelling a cooling fluid onto exposed portions of the molded articles 2. The cooling/extraction pins 14 are arranged on another molded article holding device 12 (i.e. commonly known as a COOLJET, a trademark of Husky Injection Molding Systems Ltd.), the holding device 12 arranged to be cyclically positioned between a cooling position, with the cooling/extraction pins 14 positioned adjacent the exposed portion of the molded articles 2, and an out-board position, as depicted. It is also known to use the cooling/extraction pins 14 to extract the molded articles 2 from the holders 50. The transfer of the molded articles between the holders 50 and the cooling/extraction pins 14 has been effected by various means. The steps involved in the typical transfer process include: (i) positioning the cooling/extraction pins 14 within a suitable region of the molded articles 2; (ii) connecting the cooling/extraction pins 14 to a negative pressure source, thereby creating a vacuum within the region of the molded articles 2; (iii) forcibly ejecting the molded articles 2 from the holders 50; once released from the holders 50, the molded articles 2 are captured by the cooling/extraction pins 14, under the applied vacuum, and the molded articles are extracted with the re-positioning of the holding device 12. The molded articles 2, extracted with the holding device 12, may then be re-handled and then ejected by the application of a positive fluid pressure through the cooling/extraction pins 14.

It is known to practice the step of forcibly ejecting the molded articles 2 from the holding device 15 by means of direct mechanical action, not shown. For example, commonly assigned U.S. Pat. No. 5,447,426 (Inventor: GESSNER, Dieter, et al.; Published: 5 Sep. 1995) describes a mechanically-actuated rail that bears against an outwardly extending portion of the molded articles, thereby forcing the molded articles from the holders. Such a means has proven to be a very reliable solution for ejecting the molded articles. However, not all molded articles have the requisite outwardly extending portion. In addition, such mechanical-based ejection systems do add significant weight to the holding device that requires larger driving motors to achieve the fast cycling speeds demanded by present productivity standards.

It has been known to configure the holder 50, as depicted with reference to FIG. 1B, to include a generally non-mechanical means for molded article ejection. In particular, the holder 50 includes a pressure channel 54 that is connectable to an air pressure source 18 via channel 18′, provided in a plate body 16. The pressure source 18 is configured to selectively provide overpressure or negative pressure through the pressure channel 54 to a cavity 52 defined along a tube 60 and tube insert 70. The pressure channel 54 includes a first portion, not shown, extending through the base of the tube, the first portion connecting a second portion, shown extending through a portion of the insert 70, with the pressure source 18′. The steps involved in the typical transfer process include: (i) configuring a suction air flow through the pressure channel 54 from the cavity 52 to the pressure source 18, the pressure source 18 configured as a negative pressure source, for effecting a transfer of the molded article 2 from the mold half 8 to the cavity 52; (ii) continuing the application of negative pressure through the pressure channel 54, to hold the molded article 2 in the cavity 52 of the holder 50, as the molded article 2 is cooled (by heat conduction through the tube 60 to a coolant circulating in the coolant channel 62 configured around the tube 60, and enclosed by a tube sleeve 64, the coolant channel 62 connectable to a coolant source 17, 17′ in the plate body 16); (iii) configuring the pressure source 18 to provide overpressure to the pressure channel 54, and thereby pressurize the cavity 52 and effect the ejection of the molded article 2 therefrom. Many factors affect the ejection of the molded article from the tube 2, including the geometry of the molded article 2 (e.g. a shallow draft angle on the outside of the molded article can cause the preform to stick in the tube). Suffice it to say, that not all of the molded articles 2 that are desired to be ejected simultaneously will release with common ease, and hence some molded articles may release earlier than others. Under such circumstances, when some subset of a total number of the molded articles are initially released, the cavity 52 of the corresponding holders 50 are at ambient pressure and hence the unchecked air flow from the pressure channel 54 is not being directed to the remaining holders 50 having molded articles 2 remaining therein. Accordingly, with the air flow losses associated with the venting holders 50, there may be insufficient air pressure remaining to dislodge the molded articles 2 that are more resistant to ejection in a timely manner, if at all.

FIG. 1B also shows that a fastener 72 is used to connect the holder 50 to the plate body 16, the holder configured to accommodate the fastener 72 along a passageway configured along a longitudinal axis of the holder 50. The foregoing arrangement while providing a readily serviceable connection, the technician merely needs to use a key through the pressure channel 54 to modify the connection, does have a significant drawback in that portions of the pressure channel 54, not shown, need to be off the longitudinal axis of the holder (namely the portion extending through the base of the tube 60). Accordingly, beyond the added complexity of manufacture, the foregoing arrangement does also suffer from a higher pressure drop between the pressure source 18 and the cavity 52.

Another example of a non-mechanical holder 150 is shown with reference to FIG. 2. The holder 150 is configured in much the same way as holder 50.

Wherever possible, similar features of the embodiments of the prior art and of the present invention have been given similar reference numbers and their descriptions have not been repeated.

The main difference between the two is that the holder 150 includes a checkable pressure channel 154, and an auxiliary pressure channel 136. The valve checkable pressure channel 154 includes a valve element 126 that is trapped between, at all times, a device portal 128 at the top of a portion of the pressure channel 154 that defines a valve chamber 124, and a plenum portal 130 configured at the base of the valve chamber 124. A valve seat 132 is configured adjacent the device portal 128 that cooperates with the valve element 126 for isolating the device and plenum portals 128, 130 when an overpressure is applied from the pressure source 118, 118′ to the pressure channel 154. The much narrower auxiliary pressure channel 136, relative to the pressure channel 154, is also connected to the pressure source 118, 118′, but without provision for a checkable valve. In addition, the insert 170 is configured to cooperate with the tube 160 and the fastener 72 such that it is movable along the longitudinal axis of the tube 160 to assist in supporting the molded article 2 as it is being ejected. The steps involved in the typical transfer process include: (i) configuring a suction air flow through both the pressure channel 154 (the valve element 126 resting in a configuration with respect to the plenum portal 130 such that the valve chamber maintains a fluid connection between the device and plenum portals 128, 130) and the auxiliary pressure channel 136, from the cavity 152 to the pressure source 118, the pressure source 118 configured as a negative pressure source, for affecting a transfer of the molded article 2 from the mold half 8 to the cavity 152; (ii) continuing the application of negative pressure through the pressure channels 154, 136, to hold the molded article 2 in the cavity 152 of the holder 150, as the molded article 2 is cooled; (iii) configuring the pressure source 118 to provide overpressure to the pressure channels 154, 136, the valve element 126 moving to cooperate with the valve seat 132, isolating the device portal 128 from the pressure source 118, as soon as air begins to flow into the cavity 152, the air flow through the auxiliary pressure channel 136 continuing unchecked (the auxiliary channel includes an outlet nozzle 138, which may assist in moving the insert 170 forward during ejection). The foregoing arrangement provides for reduced air pressure losses from empty holders 150, relative to the holder 50, the losses mitigated by the pressure losses through the relatively narrow auxiliary channel. Nonetheless, the auxiliary channel 136 and portions 154A and 154B of the pressure channel 154 are off-axis relative to a common connecting portion 154C of the pressure channel 154, with associated pressure losses which can affect the efficacy of the transfer from the mold 8 into the holder 150. Perhaps of more significance, is the pressure losses associated with the circuitous route in which the air must flow around the valve element 126 when effecting a suction air flow through the valve chamber 124. In particular, the device and plenum portals 128, 130 are arranged on opposite sides of the valve element 126 at all times thereby requiring the air to flow past the rather narrow gaps between the valve element and the valve chamber 124 and with associated pressure losses.

European Patent 1 123 189 B1 (Inventor: WEINMANN, Robert, et al.; Published: 29 Jan. 2003) provides yet another example of a non-mechanical variety of molded article holder that includes a pressure-biased valve check pin for controlling air flow between a cavity, defined in the holder, with a pressure source.

### SUMMARY

According to a first aspect of the present invention, there is provided a molded article holder. The molded article holder comprises an insert, a tube co-operable with the insert for defining a cavity for receiving a molded article, and a retainer co-operable with the tube for connecting the tube to a post-mold holding device. The retainer snap-engagable with the insert.

According to a second aspect of the present invention, there is provided a retainer for a molded article holder. The retainer comprises a retainer body, the retainer body co-operable with a tube, of the holder, for connecting the tube to a post-mold holding device. The tube co-operable with an insert, of the holder, for defining a cavity for receiving the molded article. The retainer body snap-engagable with the insert.

According to a third aspect of the present invention, there is provided an insert for a molded article holder. The insert comprises an insert body the insert body co-operable with a tube, of the holder, for defining a cavity for receiving the molded article. The tube co-operable with a retainer, of the holder, for connecting the tube to a post-mold holding device the insert body snap-engagable with the retainer.

A technical effect, amongst others, of the aspects of the present invention includes a self-retaining assembly of components for a molded article holder that can be stored and installed as a semi-complete unit.

A technical effect, amongst others, of the aspects of the present invention includes a simplified insert, for a molded article holder, that may be manufactured more economically.

A technical effect, amongst others, of the aspects of the present invention include improved air flow through a molded article holder for affecting a more reliable transfer of the molded article into the holder from the mold.

A technical effect, amongst others, of the aspects of the present invention includes a molded article holder having a pressure channel that may selectively blocked to conserve air from the pressure source when a corresponding mold cavity is not in service.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1A is a top elevation view of a known injection molding system;

FIG. 1B is a section view through a post-mold holding device depicted in the injection molding system of FIG. 1A;

FIG. 2 is a section view through another example of a known post-mold holding device;

FIG. 3 is an isometric view of a valve and valve cap in accordance with a presently preferred embodiment of the present invention;

FIG. 4 is a top elevation view of the valve of FIG. 3;

FIG. 5 is a section view of the valve of FIG. 3 taken along the section lines 5-5 as shown in FIG. 4;

FIG. 6 is a section view of the valve of FIG. 3 taken along the section lines 6-6 as shown in FIG. 4;

FIG. 7 is a section view of the valve of FIG. 3 taken along the section lines 7-7 as shown in FIG. 4;

FIG. 8A is a section view of a post-mold holding device in accordance with a first alternative embodiment of the present invention during a step of transfer of the molded article into a holder;

FIG. 8B is a section view of the post-mold holding device of FIG. 8A during a step of holding the molded article in the holder;

FIG. 8C is a section view of the post-mold holding device of FIG. 8A during a step of transfer of the molded article to another post-mold holding device at a moment prior to the ejection of the molded article from the holder;

FIG. 8D is a section view of the post-mold holding device of FIG. 8A during a step of transfer of the molded article to another post-mold holding device at a moment after the ejection of the molded article from the holder;

FIG. 9 is a section view of a post-mold holding device in accordance with a second alternative embodiment of the present invention;

FIG. 10 is an isometric view of a retainer of a molded article holder in accordance with the post-mold holding device of FIG. 9;

FIG. 11 is a section view of a valve in accordance with a third alternative embodiment of the present invention;

FIG. 12 is a section view of a valve in accordance with a fourth alternative embodiment of the present invention;

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EXEMPLARY EMBODIMENTS

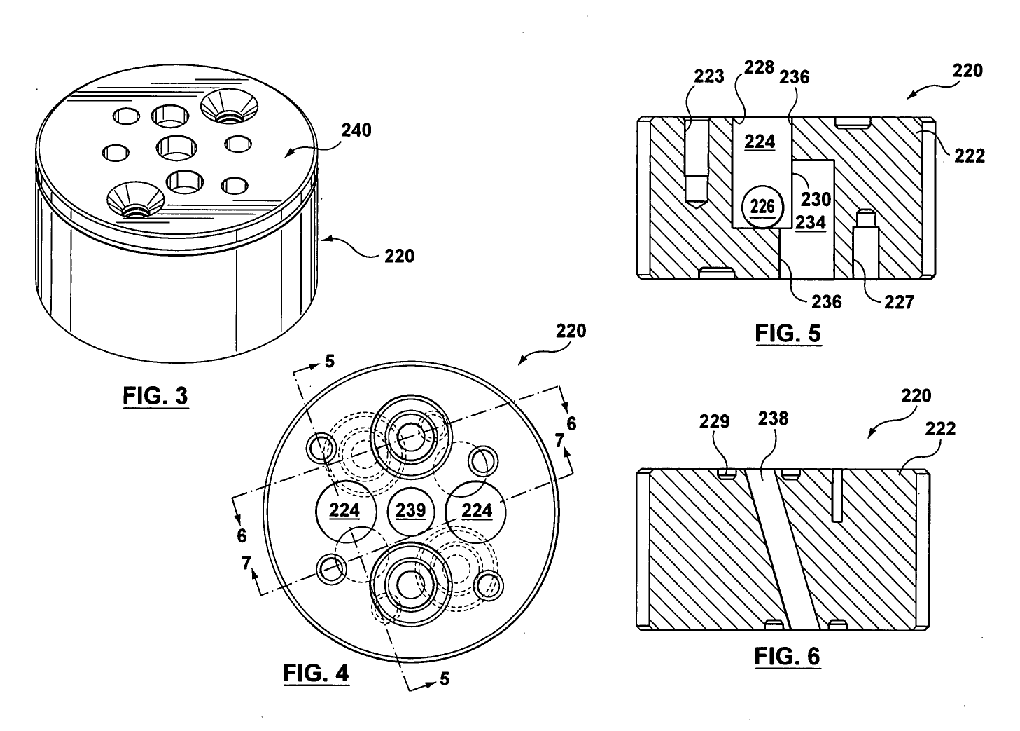

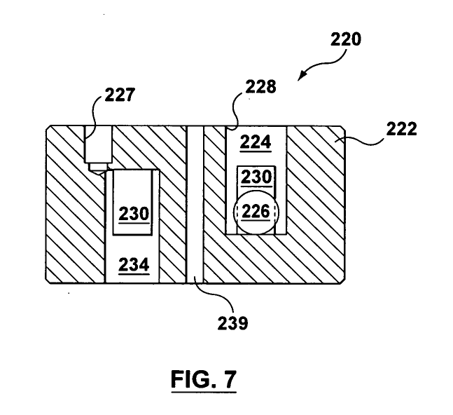

FIG. 3 is an isometric representation of the valve 220, in accordance with a presently preferred embodiment of the present invention, for controlling air flow in the pressure channel 54, 154 of the molded article holder 50, 150. With reference to the section views FIGS. 5, 6, and 7, taken through the valve 220 along the section lines indicated in FIG. 4, it can be seen that the valve 220 includes a body 222 defining a valve chamber 224 for movably receiving a valve element 226. The valve chamber 224 includes a device portal 228 and a plenum portal 230, the device portal 228 being spaced apart from the plenum portal 230, in the direction of travel of the valve element. The plenum portal 230 is connectable to a pressure source 18, 118. The device portal 228 is connectable to the pressure channel 54, 154 of the holder 54, 154. With a lower air pressure at the plenum portal 230 than the device portal 228 the valve element 226 is urged to move to an open position behind the device and plenum portals 228, 230, at least in part, thereby opening a fluid connection between the portals 228, 230, via the valve chamber 224. With a higher air pressure at the plenum portal 230 than the device portal 228, the valve element 226 is urged to move to a blocking position between the device and plenum portals 228, 230 for isolating the device portal 228 from the plenum portal 230.

A technical effect of moving the valve element behind the device and plenum portals 228, 230, at least in part, is that a fluid connection is configured therebetween having a relatively low pressure drop.

Preferably, the plenum portal 230 is configured to be longer than the valve element 226, in the direction of travel of the valve element 226, and the plenum portal 230 configured to retain the valve element 226 in the valve chamber 224, at least in part. More preferably, the plenum portal 230 is at least twice as long as the valve element 226 in the direction of travel of the valve element 226. More preferably still, in the open position, a cross-sectional area of the plenum portal 230 in front of the valve element 226 is to be configured to be substantially the same, or greater, than a cross-sectional area of the device portal 228.

Preferably, the valve element 226, in the blocking position, is sealingly co-operable with a valve seat, not shown. More particularly, the valve seat, not shown, and valve element 226 are preferably configured to have a complementary configuration. The valve seat may be configured, for example, in the valve chamber 224 of the valve body 222, on the bottom of the molded article holder 50, 150, or on another body altogether. The valve element 226 is preferably a light weight ball bearing made of steel. Of course, the valve element 226 may have other suitable shapes, for example, as a cylindrical member. The valve element 226 may also be made from other materials, for example, such as polymers (e.g. Nylon).

It is presently preferred to configure the valve seat, not shown, on a face of a valve cap 240, as shown with reference to FIG. 3, in use, the valve cap 240 is arranged between the valve 220 and the holder 50, 150. The valve cap 240 is shown as including a set of complementary connecting passageways corresponding to those of the valve 220 and holder 50, 150. In particular, there are passageways for connecting the pressure channel 54, 154 of the molded article holder 50, 150, with the device portal 228 of the valve 220. There are also passageways for connecting the coolant channels 62, 162 of the molded article holder 50, 150, with a coolant channel 238 in the valve 220, the coolant channel 238 itself connectable to the coolant source 17′ in the plate body 16, 116 of the post-mold holding device 15, 115 (also shown configured in the top and bottom faces of the valve body 222 surrounding the coolant channels 238 are seats 229 for accommodating o-ring seals). The remaining miscellaneous passageways accommodate various fasteners, dowels, and the like, for interconnecting the holder with the plate body 16, 116, and fastening the valve cap 240 on the valve 220 for retaining the valve element 226 in the valve chamber 224.

Preferably, the valve chamber 224 is fluidly connected to a plenum 234 through the plenum portal. The plenum 234 is preferably configured in the valve body 222. Alternatively, for example, the plenum may be configured in a separate body, such as in the plate body 16, 116, that is co-operable with the valve body 222. Preferably, a cross-sectional area of the plenum 234 and the valve chamber 224 are substantially the same. More preferably, the plenum portal 230 is defined by overlap-connected sidewalls 236 of the valve chamber 224 and plenum 234. More preferably, the valve chamber 224 and plenum 234 are provided by substantially straight channels that are formed in the valve body 222 in a staggered arrangement, both radially and longitudinally, and that the channels generally parallel. The foregoing channel arrangement may be formed by drilling the staggered channels through opposite sides of the valve body 222. The presently preferred plenum portal 230 therefore extends through the sidewall 236 of the valve chamber 224, in the direction of travel of the valve element 226, from a base of the valve chamber 224 to about twice a length of the valve element 226. Preferably, the valve element 226 is arranged in the valve chamber 224 such that a portion of the valve element 226 projects into the plenum 234 as the valve element 226 moves between the open position and a valve blocking position.

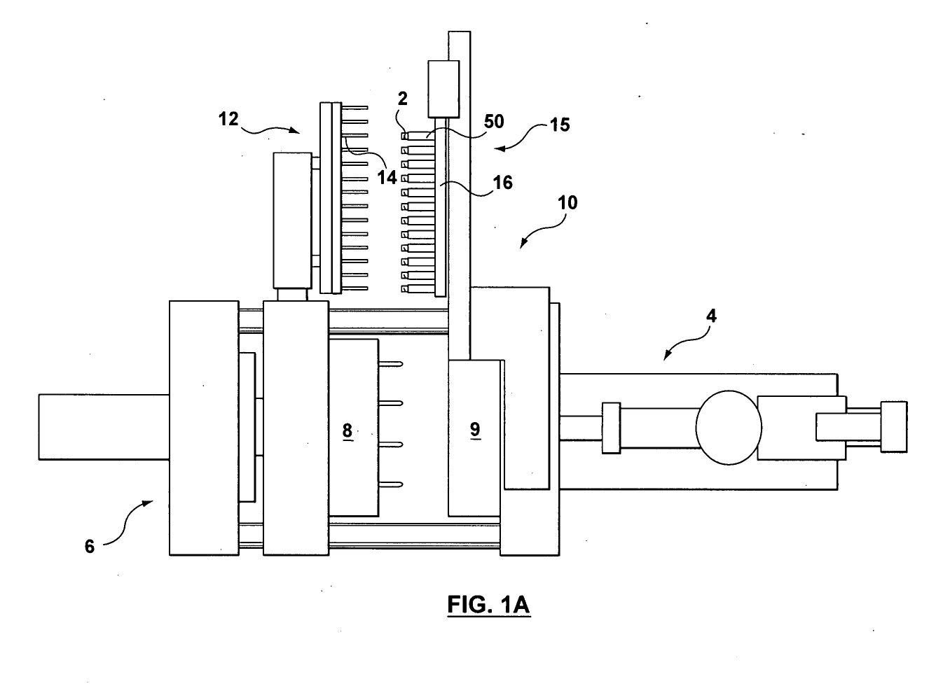

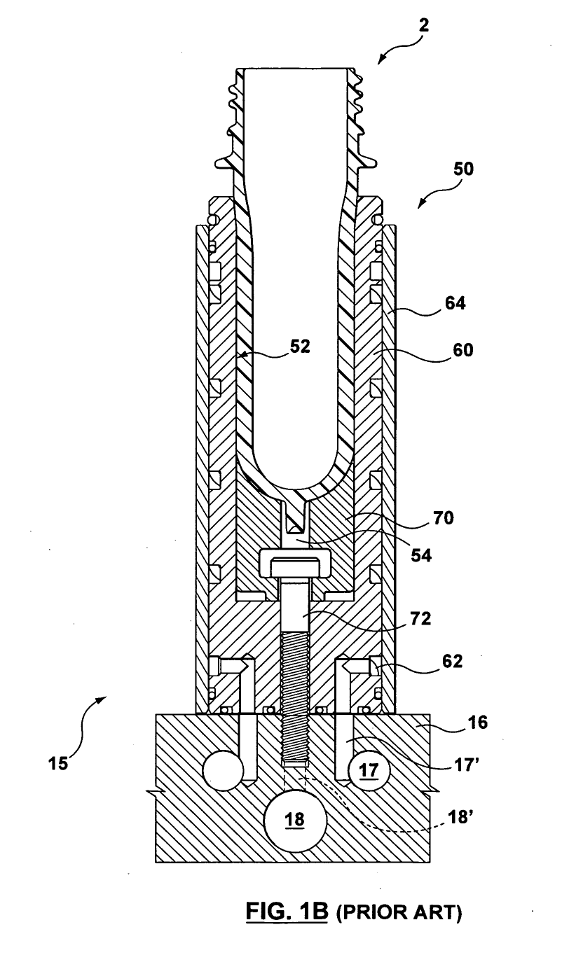

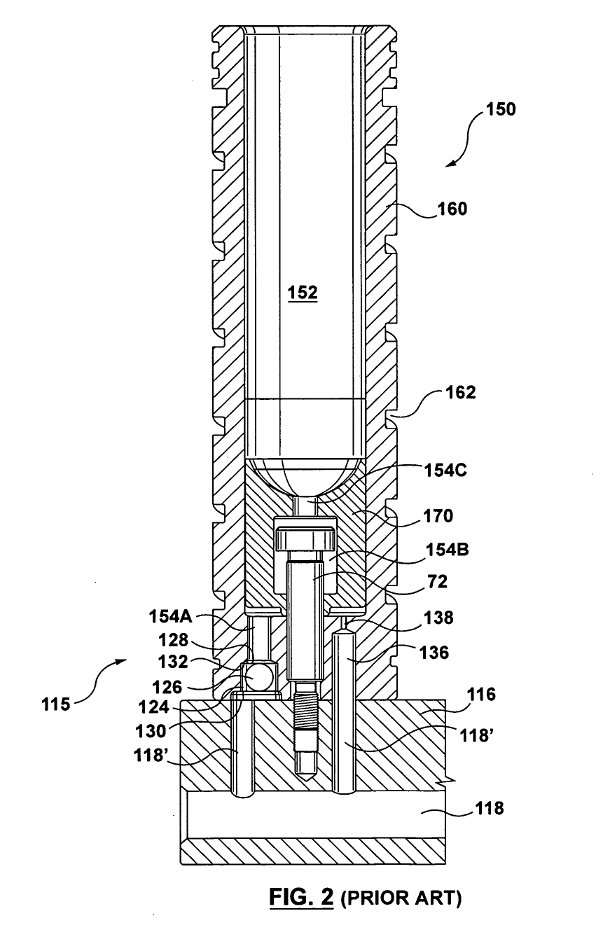

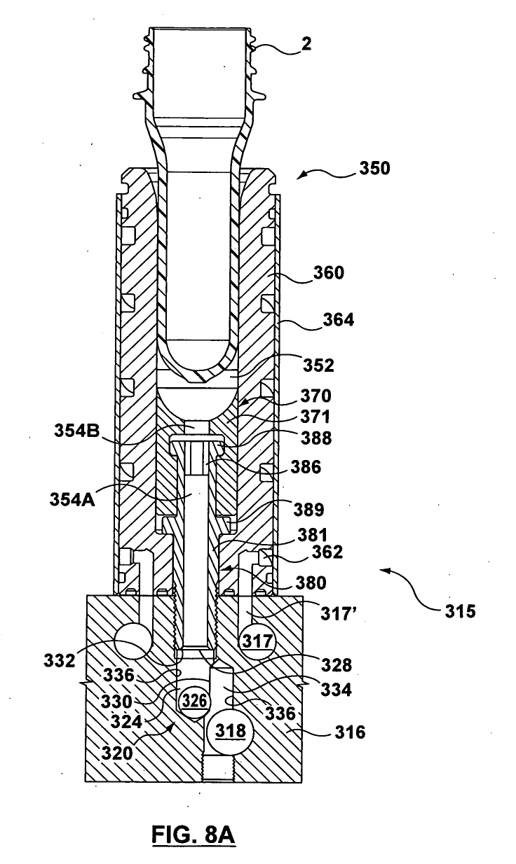

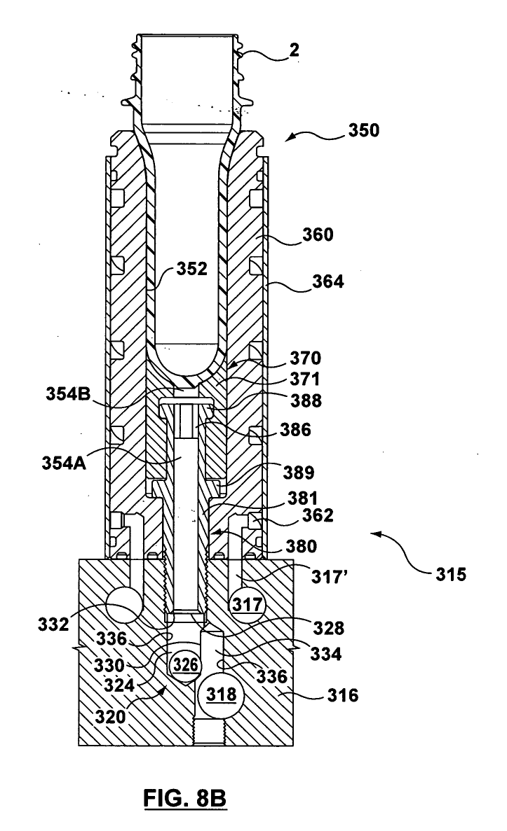

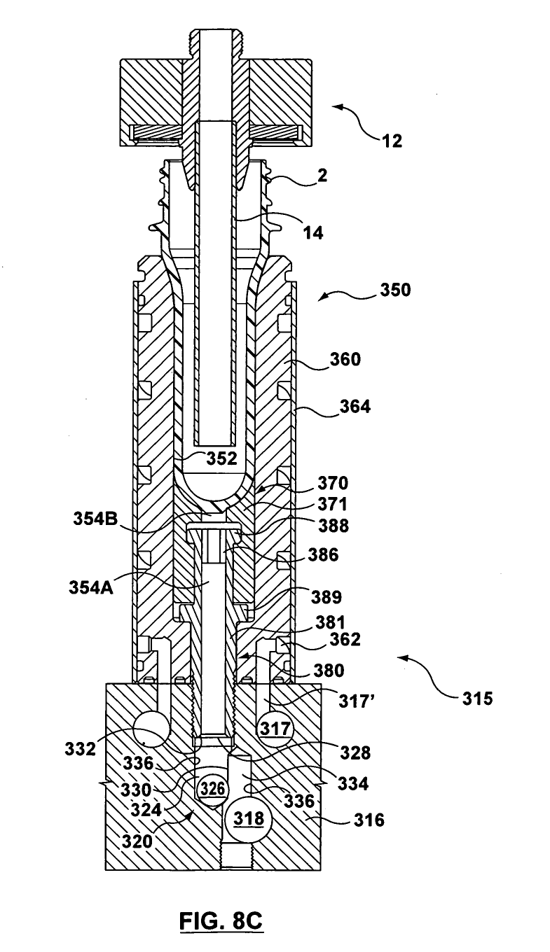

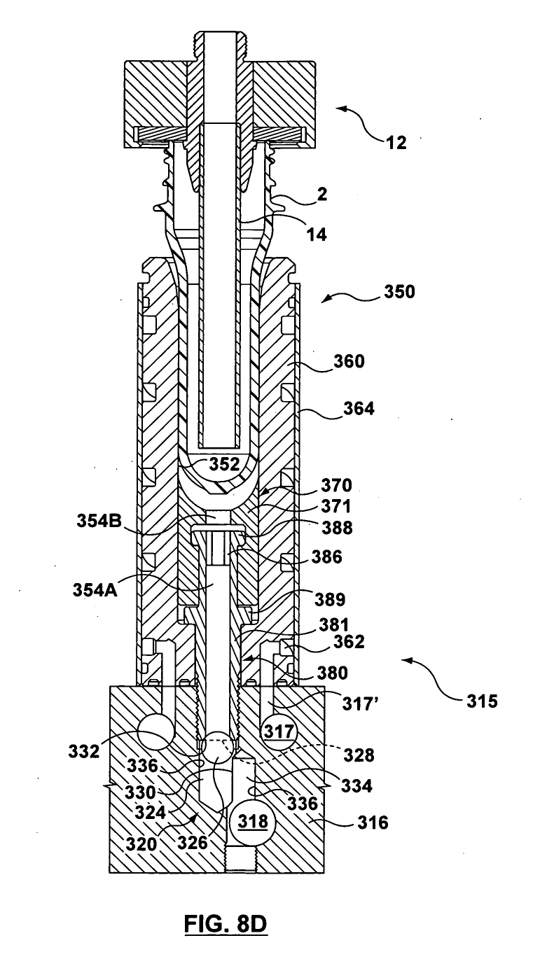

With reference to FIGS. 8A through 8D, a sequence of steps for a post-mold holding, and cooling, of a molded article 2 are depicted using a post-mold holding device 315 in accordance with a first alternative embodiment of the present invention in conjunction with the injection molding system 10, reference FIG. 1A, and as described hereinbefore. The post-mold holding device 315 includes a molded article holder 350 mounted on a plate body 316. The molded article holder 350 is similar to holder 50 described hereinbefore. An exception to the foregoing is in that a retainer 380 replaces the fastener 72. The retainer 380 is provided by a generally cylindrically-shaped retainer body 381 that defines a portion of a pressure channel 354A, extending through the retainer body 381 along its longitudinal axis, for connecting another portion of the pressure channel 354B, configured in the insert 370, with a device portal 328 of a valve 320. The valve 320 is configured in the plate body 316 consistent with the valve 220 described hereinbefore. Preferably, a valve seat 332 of the valve 320 is configured at the base of the retainer 380 around the opening of the pressure channel portion 354A. Advantageously, the valve seat 332 can be inexpensively replaced, when worn, by simply replacing the relatively inexpensive retainer 380. Preferably, the retainer 380 is made from a durable grade of steel. The retainer 380 also preferably includes a tooling interface 386 configured along a top portion of the pressure channel portion 354A. The tooling interface 386 is accessible, by a key, through the pressure channel 354 for manipulating a threaded connection provided along a recess in the plate body 316 and a lower outer portion of the retainer 380. The retainer body 381 also defines a first and second flange 388, 389 for trapping the insert 370 in the tube 360.

FIG. 8A shows the molded article 2 as it is being transferred into the cavity 352 of the molded article holder 350 from the mold, not shown. The pressure source 318 is configured to provide negative pressure to the plenum 334 that acts on the valve element 326, through the plenum portal 330, to urge the valve element into an open position, as depicted, that is behind both the device and plenum portals 328, 330, at least in part. The valve 320, with the valve member 326 in the open position, supports a suction air flow between the cavity 352 and the pressure source 318 for sucking the molded article 2 into the holder 350.

FIG. 8B shows the molded article 2 as it is being held in the cavity 352 of the molded article holder 350. The pressure source 318 is preferably configured to maintain negative pressure to the plenum 334, to keep the shrinking molded article 2 (from the effects of cooling) firmly retained in the molded article holder 350.

FIG. 8C shows the molded article 2 during a step of transfer of the molded article 2 from the post-mold holding device 315 to another post-mold holding device 12. In particular, the valve element 326 is shown in the open position, behind the portals 328, 330, at an instant after the pressure source 318 is reconfigured to provide overpressure to the plenum 334, and before the molded article 2 is dislodged from the cavity 352 of the molded article holder 350. A cooling/extraction pin 14, of the post-mold holding device 12 is positioned in the molded article 2 waiting to receive the molded article 2.

FIG. 8D shows the molded article 2 during a step of extraction of the molded article 2, having been released from the post-mold holding device 315, by the post-mold holding device 12. In particular, the valve element 326 is shown in the blocking position, between the portals 328, 330, and sealed against the valve seat 332, and hence the device portal 328 is isolated from the overpressure.

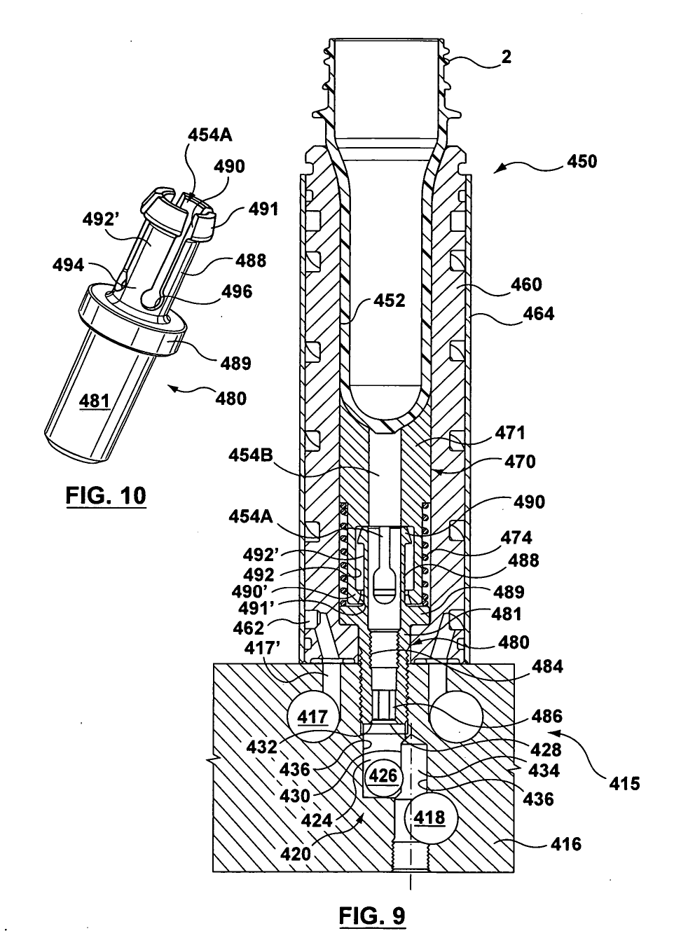

With reference to FIGS. 9 and 10 a post-mold holding device 415 in accordance with a second alternative embodiment of the present invention is depicted. The post-mold holding device 415 includes a molded article holder 450 mounted on a plate body 416. The molded article holder 450 and plate body 416, including valve 420, are similar to the holder 350 and plate body 315 as described hereinbefore. An exception to the foregoing is with the configuration and interplay of the retainer 480 and insert 470. In particular, the molded article holder 450 comprises an insert 470, a tube 460 co-operable with the insert 470 for defining a cavity 452 for receiving a molded article 2, and a retainer 480 co-operable with the tube 460 for connecting the tube 460 to the post-mold holding device 415. The retainer 480 is snap-engagable with the insert 470.

Preferably, the insert 470 and the retainer 480 include complementary tongue and groove members 490, 492 linked thereto. One of the tongue and groove members 490, 492 arranged on a plurality of fingers 488 linked to one of the insert 470 and the retainer 480, the fingers 488 deflectable to allow the tongue and groove members 490, 492 to engage, the fingers 488 resiliently biased to a neutral position for retaining the tongue member 490 in the groove member 492.

Alternatively, one of the tongue and groove members 490, 492 may be arranged on a deformable portion, not shown, linked to one of the insert 470 and the retainer 480, the deformable portion elastically deformable to allow the tongue and groove members 490, 492 to engage.

Preferably, a leading edge of the tongue member 490 is configured to include a camming portion 491 to assist with the deflection of the fingers 488.

Preferably, the tongue and groove members 490, 492 are co-operable for a slidable engagement of the tongue member 490 along the groove member 492, and hence a relative sliding movement between the insert 470 and the retainer 480.

In accordance with yet another embodiment, not shown, the tongue and groove members 490, 492 are co-operable for generally preventing relative movement between the insert 470 and the retainer 480.

Preferably, the fingers 488, with the one of the tongue and groove members 490, 492 arranged thereon, are configured on the retainer 480. Alternatively, the fingers 488, with the one of the tongue and groove members 490, 492 arranged thereon, are configured on the insert 470. In accordance with yet another alternative, the fingers 488, with the one of the tongue and groove members 490, 492 arranged thereon, are configured on both the retainer 480 and the insert 470.

Preferably, the retainer 480 includes a pressure channel 454A extending therethrough for connecting a pressure channel 454B of the insert 470 with the pressure source 418.

Preferably, the retainer 480 includes a valve seat 432 configured adjacent a portal to the pressure channel 454A, the valve seat 432 configured to cooperate with the valve element 426.

Preferably, the retainer 480 includes a threaded seat 484 configured in the pressure channel 454A that is co-operable with a set screw, not shown, when it is desired to temporarily block the pressure channel 454A.

Preferably, the retainer 480 is co-operable with the insert 470 for trapping a resilient member 474 therebetween that forward-biases the insert 470 relative to the retainer 480. Advantageously, the resiliently-biasing the insert 470 maintains contact between the end portion of the molded article 2 and the insert as the molded article shrink fits into the cavity 452 with cooling. In particular, the resilient member 474 is preferably trapped between a flange 489, defined on the retainer body 481, and a circumferential step formed on an outside surface of the insert body 471.

Preferably, the retainer 480 includes a tool interface 486 for manipulating the connection between the tube 460 and the post-mold holding device 415.

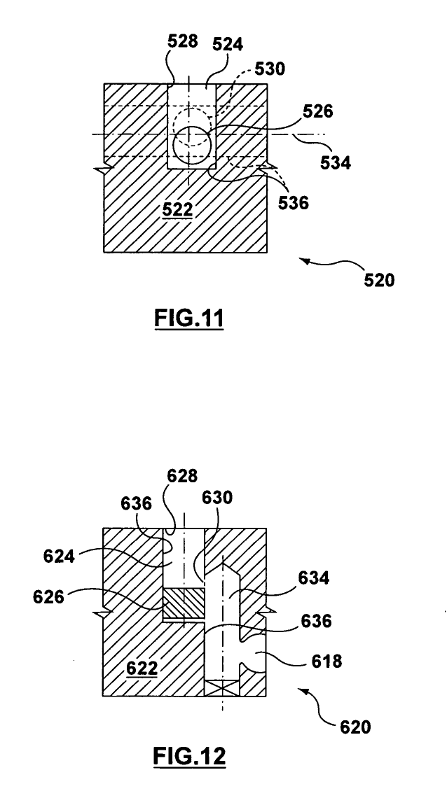

With reference to FIG. 11 a valve 520 in accordance with a third alternative embodiment of the present invention is depicted. The valve 520 is similar to the valve 220, described hereinbefore, with the plenum portal 530 being defined by overlap-connected sidewalls 536 of the valve chamber 524 and plenum 534. An exception to the foregoing is that the channels providing the valve chamber 524 and plenum 534 are generally perpendicular to each other.

With reference to FIG. 12 a valve 620 in accordance with a fourth alternative embodiment of the present invention is depicted. The valve 620 is similar to the valve 220, described hereinbefore with the exception that the valve element 636 is a generally cylindrical member.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A molded article holder (450), comprising:
an insert (470);
a tube (460) co-operable with the insert (470) for defining a cavity (452) for receiving a molded article (2);
a retainer (480) co-operable with the tube (460) for connecting the tube (460) to a post-mold holding device (415);
the retainer (480) snap-engagable with the insert (470).

2. The molded article holder (450) according to claim 1, wherein:
the insert (470) and the retainer (480) include complementary tongue and groove members (490, 492) linked thereto;
one of the tongue and groove members (490, 492) arranged on a plurality of fingers (488) linked to one of the insert (470) and the retainer (480), the fingers (488) deflectable to allow the tongue and groove members (490, 492) to engage, the fingers (488) resiliently biased to a neutral position for retaining the tongue member (490) in the groove member (492).

3. The molded article holder (450) according to claim 2, wherein:
the tongue and groove members (490, 492) co-operable for substantially preventing relative movement between the insert (470) and the retainer (480).

4. The molded article holder (450) according to claim 2, wherein:
the tongue and groove members (490, 492) co-operable for a slidable engagement of the tongue member (490) along the groove member (492), and hence a relative sliding movement between the insert (470) and the retainer (480).

5. The molded article holder (450) according to claim 2, wherein:
the fingers (488), with the one of the tongue and groove members (490, 492) arranged thereon, are configured on the retainer (480).

6. The molded article holder (450) according to claim 2, wherein:
the fingers (488), with the one of the tongue and groove members (490, 492) arranged thereon, are configured on the insert (470).

7. The molded article holder (450) according to claim 4, wherein:
the retainer (480) includes a pressure channel (454A) extending therethrough for connecting a pressure channel (454B) of the insert (470) with a pressure source (418).

8. The molded article holder (450) according to claim 7, wherein:
the retainer (480) includes a valve seat (432) configured adjacent a portal to the channel (454A), the valve seat (432) configured to cooperate with a valve element (426).

9. The molded article holder (450) according to claim 7, wherein:
the channel in the retainer (480) configured to be selectively blocked.

10. The molded article holder (450) according to claim 4, wherein:
the retainer (480) is configured to cooperate with the insert (470) in trapping a resilient member (472) therebetween that forward-biases the insert (470) relative to the retainer (480).

11. The molded article holder (450) according to claim 1, wherein:
the retainer (480) includes an tool interface (486) for manipulating the connection between the tube (460) and the post-mold holding device (415).

12. The molded article holder (450) according to claim 2, wherein:
a leading edge of the tongue member (490) are configured to include a camming portion (491) to assist with the deflection of the fingers (488).

13. A retainer (480) for a molded article holder (50), the retainer (480) comprising:
a retainer body (481);
the retainer body (481) co-operable with a tube (460), of the holder (450), for connecting the tube (460) to a post-mold holding device (415);
the tube (460) co-operable with an insert (470), of the holder (450), for defining a cavity (452) for receiving the molded article (2);
the retainer body (481) snap-engagable with the insert (470).

14. The retainer (480) according to claim 13, wherein:
the insert (470) and the retainer (480) snap-engagable through complementary tongue and groove members (490, 492) linked thereto;
one of the tongue and groove members (490, 492) arranged on a plurality of fingers (488) linked to one of the insert (470) and the retainer (480), the fingers (488) deflectable to allow the tongue and groove members (490, 492) to engage, the fingers (488) resiliently biased to a neutral position for retaining the tongue member (490) in the groove member (492).

15. The retainer (480) according to claim 14, wherein:
the tongue and groove members (490, 492) co-operable for substantially preventing relative movement between the insert (470) and the retainer (480).

16. The retainer (480) according to claim 14, wherein:
the tongue and groove members (490, 492) co-operable for a slidable engagement of the tongue member (490) along the groove member (492), and hence a relative sliding movement between the insert (470) and the retainer (480).

17. The retainer (480) according to claim 14, wherein:
the fingers (488), with the one of the tongue and groove members (490, 492) arranged thereon, are configured on the retainer (480).

18. The retainer (480) according to claim 14, wherein:
the fingers (488), with the one of the tongue and groove members (490, 492) arranged thereon, are configured on the insert (470).

19. The retainer (480) according to claim 16, wherein:
the retainer (480) includes a pressure channel (454A) extending therethrough for connecting a pressure channel (454B) of the insert (470) with a pressure source.

20. The retainer (480) according to claim 19, wherein:
the retainer (480) includes a valve seat (432) configured adjacent a portal to the channel (82), the valve seat (432) configured to cooperate with a valve element (426).

21. The retainer (480) according to claim 19, wherein:
the channel in the retainer (480) configured to be selectively blocked.

22. The retainer (480) according to claim 16, wherein:
the retainer (480) is configured to cooperate with the insert (470) in trapping a resilient member (472) therebetween that forward-biases the insert (470) relative to the retainer (480).

23. The retainer (480) according to claim 13, wherein:
the retainer (480) includes an tool interface (486) for manipulating the connection between the tube (460) and the post-mold holding device (415).

24. The retainer (480) according to claim 14, wherein:
a leading edge of the tongue member (490) are configured to include a camming portion (491) to assist with the deflection of the fingers (488).

25. An insert (470) for a molded article holder (450), the insert (470) comprising:
an insert body (471);
the insert body (471) co-operable with a tube (460), of the holder (450), for defining a cavity (452) for receiving the molded article (2);
the tube (460) co-operable with a retainer (480), of the holder (450), for connecting the tube (460) to a post-mold holding device (415);
the insert body (471) snap-engagable with the retainer (480).

26. The insert (470) according to claim 25, wherein:
the insert (470) and the retainer (480) snap-engagable through complementary tongue and groove members (490, 492) linked thereto;
one of the tongue and groove members (490, 492) arranged on a plurality of fingers (488) linked to one of the insert (470) and the retainer (480), the fingers (488) deflectable to allow the tongue and groove members (490, 492) to engage, the fingers (488) resiliently biased to a neutral position for retaining the tongue member (490) in the groove member (492).

27. The insert (470) according to claim 26, wherein:
the tongue and groove members (490, 492) co-operable for substantially preventing relative movement between the insert (470) and the retainer (480).

28. The insert (470) according to claim 26, wherein:
the tongue and groove members (490, 492) co-operable for a slidable engagement of the tongue member (490) along the groove member (492), and hence a relative sliding movement between the insert (470) and the retainer (480).

29. The insert (470) according to claim 26, wherein:
the fingers (488), with the one of the tongue and groove members (490, 492) arranged thereon, are configured on the retainer (480).

30. The insert (470) according to claim 26, wherein:
the fingers (488), with the one of the tongue and groove members (490, 492) arranged thereon, are configured on the insert (470).

31. The insert (470) according to claim 26, wherein: a leading edge of the tongue member (490) are configured to include a camming portion (491) to assist with the deflection of the fingers (488).
